(19) United States
(12) Patent Application Publication
(10) Pub. No.: US 2025/0091846 A1
(43) Pub. Date: Mar. 20, 2025

(54) PORTABLE LOADING DOCK

(71) Applicant: Ballymore Company, Inc., Coatsville, PA (US)

(72) Inventors: William F. Frame, Coatsville, PA (US); John Sayles, West Chester, PA (US)

(73) Assignee: Ballymore Company, Inc., Coatsville, PA (US)

(21) Appl. No.: 18/889,877

(22) Filed: Sep. 19, 2024

Related U.S. Application Data
(60) Provisional application No. 63/583,379, filed on Sep. 18, 2023.

(51) Int. Cl. B66F 9/065; B62B 3/02; B66F 9/12; B66F 9/22

(52) U.S. Cl. CPC B66F 9/065; B62B 3/02; B66F 9/12; B66F 9/22

(57) ABSTRACT

A portable loading dock includes a base and a platform. The portable loading dock includes a plurality of scissor legs having lower legs attached to the base and upper legs attached to the platform. One of the lower legs is pivotably connected to the base while another of the lower legs is slidably attached to the base via a slider assembly. One of the upper legs is pivotably connected to the deck while another of the lower legs is slidably attached to the base via a slider assembly. A drive unit is attached to at least one of the scissor legs to raise and lower the platform relative to the base wherein the portable loading dock functions to move a payload from floor level onto the portable loading dock to a raised unloading position level.

### CROSS REFERENCE TO RELATED APPLICATIONS

This application also claims the benefit of U.S. Provisional Application No. 63/583,379, filed Sep. 18, 2023. The entire disclosure of which is incorporated herein by reference.

### STATEMENT REGARDING FEDERALLY SPONSORED RESEARCH OR DEVELOPMENT

The present invention was not developed with the use of any Federal Funds, but was developed independently by the inventors.

### BACKGROUND

### 1. Field

Lift tables or docks are useful for receiving and supporting a load on a substantially flat surface, changing the height of the surface (e.g., by a hydraulic device) and rolling the lift dock to a desired location (e.g., using casters). A portable loading dock functions to move a payload from floor level to a raised vehicle bed height to load and unload payloads.

Accordingly, it would be useful to provide such a portable loading dock to eliminate the inconvenience and expense of ramps, pits and fork trucks. Such a portable loading dock functions to move a payload from floor level easily onto the portable loading dock, since it lowers flush with the floor or ground level, raises the payload up to the vehicle bed height under power and position the portable loading dock over the vehicle bed to unload the payload via roll-on loading, roll-off unloading

### SUMMARY

Disclosed herein is a portable loading dock. The portable loading dock includes a base and a platform. The portable loading dock includes a plurality of scissor legs having lower legs attached to the base and upper legs attached to the platform. One of the lower legs is pivotably connected to the base while another of the lower legs is slidably attached to the base via a slider assembly. One of the upper legs is pivotably connected to the deck while another of the lower legs is slidably attached to the base via a slider assembly. A drive unit is attached to at least one of the scissor legs to raise and lower the platform relative to the base wherein the portable loading dock functions to move a payload from floor level onto the portable loading dock to a raised unloading position level.

In one form of the invention the portable loading dock includes a tongue for facilitating roll-on loading and roll-off unloading of the payload. Extendible hand rails may be provided for operator safety while moving the payload, the handrails are extendable to provide additional safety. The portable loading dock may include an optional power drive.

In another form of the invention the lower sliding assembly may include a track having a slot located on a leg of the base and a roller is attached to one end of the lower legs which coacts with the track and slot of the slider assembly.

### BRIEF DESCRIPTION OF THE DRAWINGS

The embodiments will be described in detail with reference to the following drawings in which like reference numerals refer to like elements wherein:

FIG. 1 shows a perspective view of a portable loading dock in accordance with the present invention.

FIG. 2 shows a perspective view of the portable loading dock of FIG. 1 in the raised position.

FIG. 3 shows a side view of the portable loading dock of FIG. 1.

FIG. 4 shows a rear view of portable loading dock of FIG. 1.

FIG. 5 shows a top view of portable loading dock of FIG. 1.

FIG. 6 shows a perspective view of the portable loading dock of FIG. 1 in the lowered position.

FIG. 7 shows a perspective view of a second preferred embodiment of the portable loading dock.

FIG. 8 shows a top perspective view of a second preferred embodiment of the portable loading dock of FIG. 7.

FIG. 9 shows an enlarged view of the lower slider assembly for the portable loading docks.

FIG. 10 shows a bottom perspective view of a second preferred embodiment of the portable loading dock of FIG. 7.

FIG. 11 shows an enlarged view of the upper slider assembly for the portable loading docks.

### DETAILED DESCRIPTION

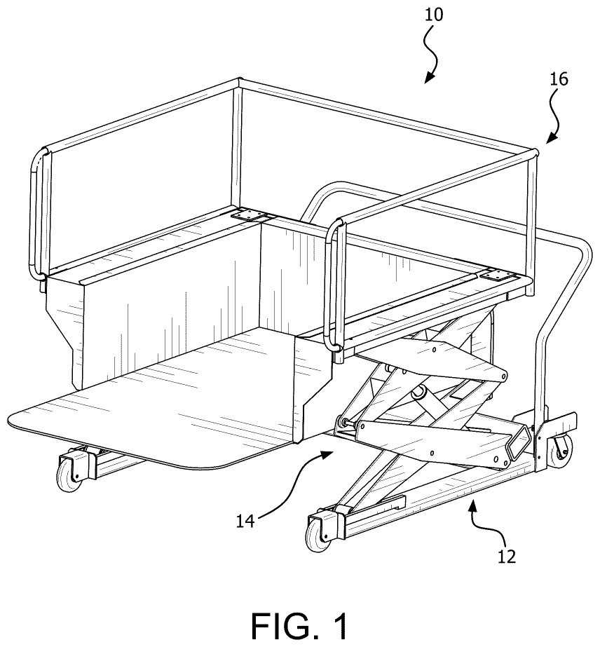

In FIG. 1 there is shown a preferred embodiment of a portable loading dock 10 in accordance with the present invention.

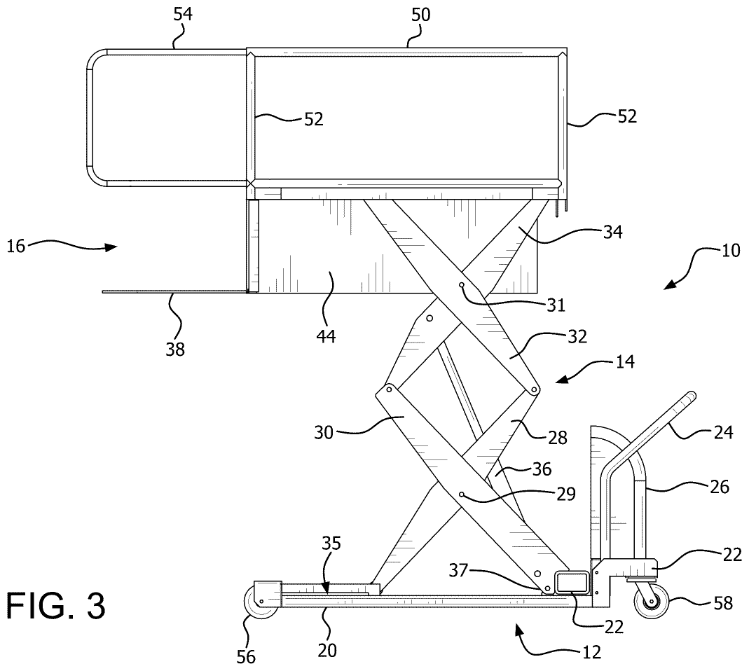

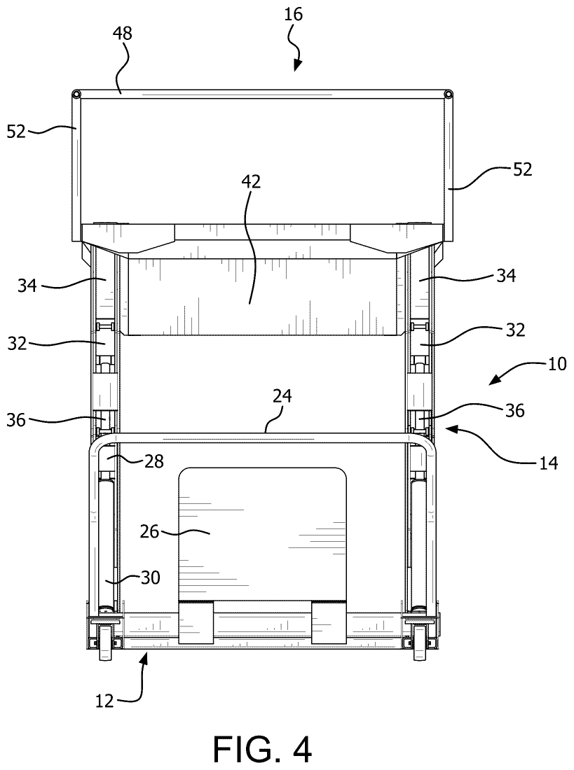

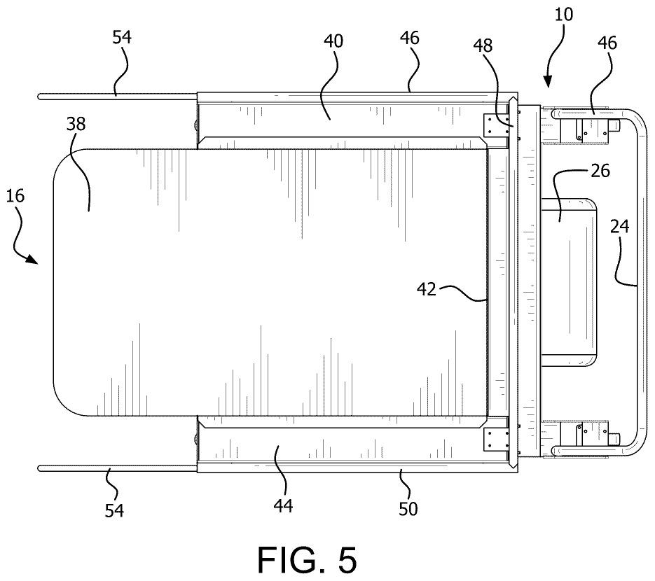

FIGS. 1 through 6 depict a portable scissors-type hydraulically-driven lift table or dock 10. The dock 10 includes a raiseable and lowerable deck or platform 16 moveably attached to a lower frame or base 12 via a two pairs of scissor legs 14.

The base 12 comprises a rear cross rail 17. A pair of extending legs 18 and 20 are attached to the rear cross bar 17. The legs 18 and 20 have upper horizontal planar surfaces.

The dock 16 form a raiseable lowerable platform as described below having a pair of rails 19 extending outboardly at each side of the platform.

The scissor legs 14 each comprise a pair of lower legs 28 and 30 and a pair of upper legs 32 and 34. Each lower leg 28 is pivotally attached to leg 30 at a central pivot point 29 to create a scissors. Similarly, each upper leg 32 is pivotally attached to upper leg 34 at a central pivot point 31 to create a scissors as well. In addition, one end of lower leg 28 is pivotably coupled to one end of upper leg 32 via a pivot 33, while One end of lower leg 30 is pivotably coupled to one end of upper leg 34 via a pivot 35.

The other end of lower leg 30 is attached to the legs 18 and 20, respectively, of the base 12 via a hinge or pivot connection 37 attached to each leg 18 and 20, respectively of base 12. The other end of lower leg 30 also comprises an L-shaped cut-out portion which interacts with crossbar 22, described in greater detail below. Similarly, other end of upper leg 34 is pivotably attached to each outboard rail 19 of the rear of platform 16 at pivot connect 69 (see FIG. 11).

The bottom legs 28 of the lower scissor legs 14 are slidably coupled to the base 12 via a slider assembly connection 35, as described in greater detail below. Similarly, the upper legs 32 of the scissor legs 14 are slidably coupled to the deck 16 via a slider assembly connection 39 formed in the outboard rail 19 of the deck 16.

In this way the two pairs of scissors legs 14 form a double scissor assembly in which spreading the legs of the scissors lowers the deck relative to the base 12 and unspreading the legs serves to raise the platform, as described in greater detail below.

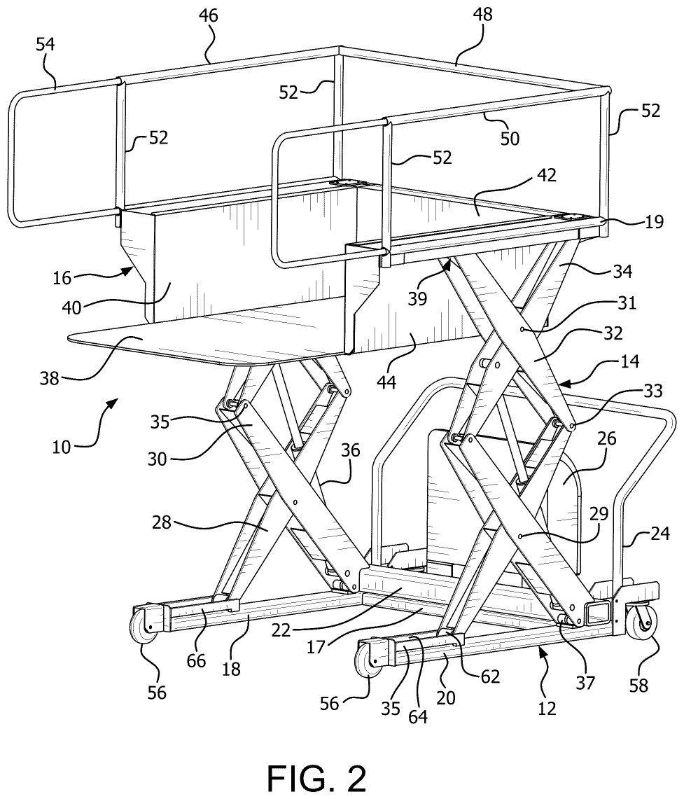

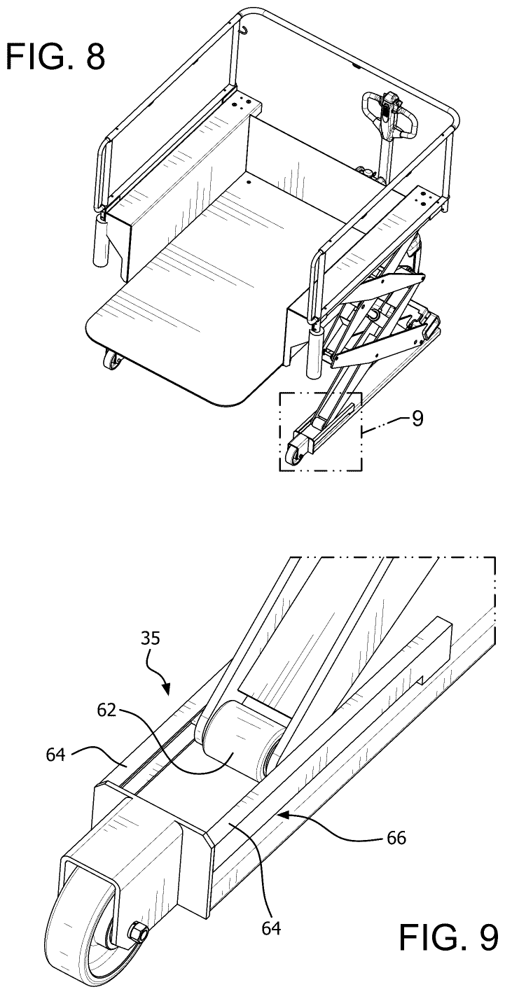

As best seen in FIGS. 2 and 8, the lower slider assembly 35 includes a slider 62, e.g. a wheel or the like, and a track 64 having a slot 66. The slider 35 is disposed on one ends of leg 28, and, as part of the scissors motion described below, is free to move within the slider track 64 and slot 66 located on the upper side of the horizontal surfaces of legs 18 and 20 of base 12.

Similarly, As best seen in FIGS. 2 and 11, the upper slider assembly 39 includes a slider and a track 67 formed by the underside surface and extending walls of the rail 19 of deck 16 and a roller 68 located at the end of leg 32. The slider assembly 39 is disposed on one end of leg 32, and, as part of the scissors motion described below, the roller 68 is free to move within the slider track 67 of rail 19 located on the deck 16. A pivot connection 69 attaches the leg 34 to the rail 19 of the dock 16, as described above.

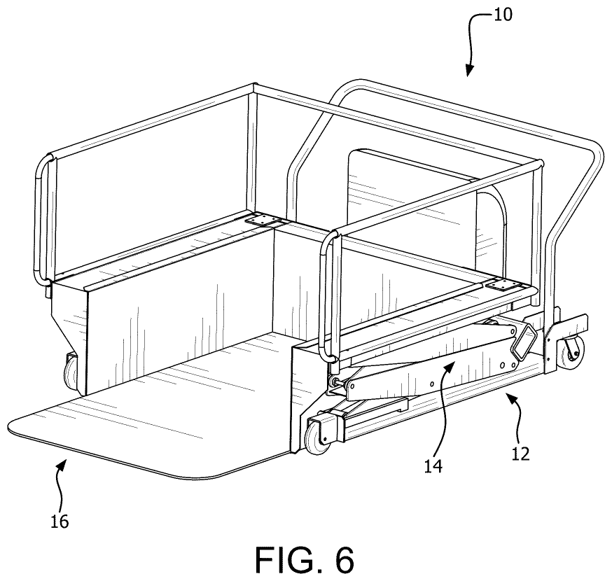

A drive or motive device such as a hydraulic cylinder or actuator 36, which may be powered by an electric or air driven pump or the like. Energy for the pump may be provided from an on-board power drive 26 which extends or retracts a cylinder rod. One end of each hydraulic cylinder is attached to the hinge or pivot points 37 attached to the base 12 while the end of the extending rod is attached to an intermediate pivot point located on upper leg 34. In the depicted embodiment, when the hydraulic cylinder 36 is activated to retract the rod, the retraction pulls on leg 34 which causes the upper arms 32 and 34 to spread which causes leg 34 to pivot while leg 32 slides in the slide assembly 39 of rail 19 towards the front of the deck and causes which causes the lower arms 28 and 30 to spread which causes leg 30 to pivot while leg 28 slides in the lower slide assembly 35 of the base towards the front of the base, drawing the deck 16 downward toward a lower position in a scissors-like fashion. Thus, lowering the deck 16, while the traveling ends of the scissors legs move linearly within the slide assemblies to the lowered position shown in FIG. 6. Similarly, controlling the drive device to extend the scissor arms 12 and 14 raises the deck 16 to the raised position shown in FIGS. 2-4.

In this way the deck or platform 16 can be lowered flush with the floor via a lifting mechanism (in this case, the scissors and hydraulic cylinders depicted). A rigid coupling 17 between the legs 12 and 14 on the opposite sides improve platform stability. The control unit 26 comprises hydraulic power and a control pendant to facilitate user control. Casters and/or glides 56 and 58 provide for portability and movability of the device 10.

The platform 16 includes walls 40, 42, and 44 and a tongue 38 that can be located over the bed of a vehicle to facilitate the transfer of the payload onto the vehicle. Handrails 46, 48, 50, 52 are provided for operator safety while moving the payload. The handrails are optionally extendable to provide additional safety over the vehicle bed as depicted by reference numeral 54. The mobile structure can have an optional power drive 26.

The portable loading dock 10 functions to move a payload from floor level easily onto the portable loading dock, since it lowers flush with the floor or ground level, raises the payload up to the vehicle bed height under power and position the portable loading dock 10 over the vehicle bed to unload the payload via roll-on loading, roll-off unloading.

The portable dock may also include manual push rail 24 to manually move the dock 10 if desired.

The portable loading dock 10 eliminates inconvenience and expense of ramps, pits and fork trucks. The dual scissors arrangement, aided by a torsion bar, are synchronized for level, uniform lift. Each cylinder may be hydraulically activated and have hydraulic lift up and gravity lowering or may employ a double acting power cylinder system.

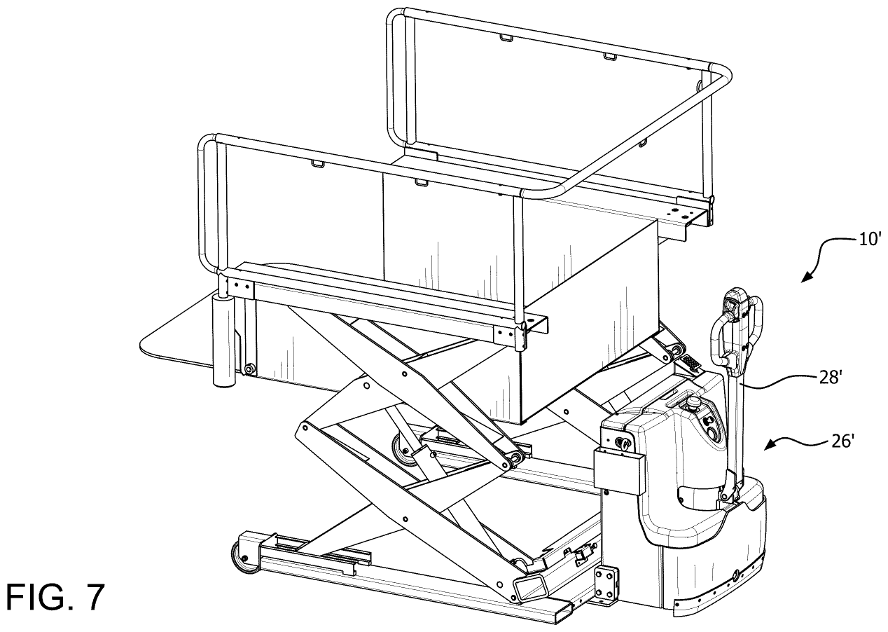

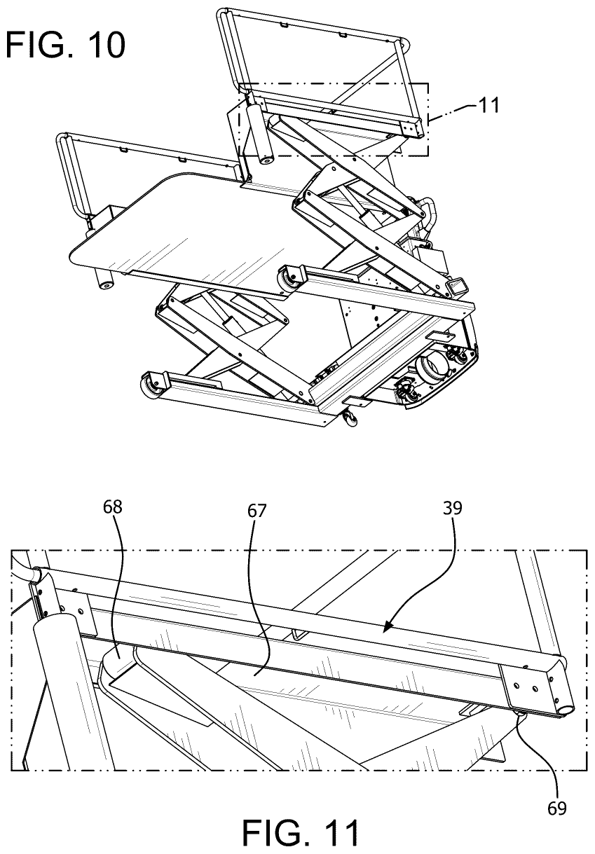

In FIGS. 7, 8, and 10, there is shown a second preferred embodiment of the invention in which the control unit 26′ is a manual hydraulic device in which an operator operates the drive 26′ and steers the loading dock 10′ via an operator's handle 28′.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A portable loading dock comprising:
a base and a platform;
a plurality of scissor legs, each pair of scissor legs comprising lower legs attached to the base and upper legs attached to the platform, one of the lower legs being pivotably connected to the base, an other of the lower legs is slidably attached to the base via a slider assembly, one of the upper legs being pivotably connected to the deck, an other of the lower legs is slidably attached to the base via a slider assembly; and
a drive attached to at least one of the scissor legs to raise and lower the platform relative to the base wherein the portable loading dock functions to move a payload from floor level onto the portable loading dock to a raised unloading position level.

2. The portable loading dock in accordance with claim 1 wherein the platform includes a tongue for facilitating roll-on loading and roll-off unloading of the payload.

3. The portable loading dock in accordance with claim 1 wherein extendible hand rails are provided for operator safety while moving the payload, the handrails are extendable to provide additional safety.

4. The portable loading dock in accordance with claim 1 wherein the portable loading dock has an optional power drive.

5. The portable loading dock in accordance with claim 1 wherein the lower sliding assembly comprises a track having a slot located on a leg of the base and a roller is attached to one end of the lower legs which coacts with the track and slot of the slider assembly.

6. The portable loading dock in accordance with claim 5 wherein the drive is an hydraulic actuator having one end attached to the base and an other end attached to one of the scissor legs.

7. The portable loading dock in accordance with claim 6 wherein the platform includes a tongue for facilitating roll-on loading and roll-off unloading of the payload.

8. The portable loading dock in accordance with claim 7 wherein extendible hand rails are provided for operator safety while moving the payload, the handrails are extendable to provide additional safety.

9. The portable loading dock in accordance with claim 8 wherein the portable loading dock has an optional power drive.
